(19) United States
(12) Patent Application Publication
(10) Pub. No.: US 2008/0218575 A1
(43) Pub. Date: Sep. 11, 2008

(54) APPLYING A PRINTED MARK TO AN ARTICLE IN THE TOBACCO-PROCESSING INDUSTRY

(75) Inventor: Helmut VOSS, Lockstedt (DE)

Correspondence Address: GREENBLUM & BERNSTEIN, P.L.C., 1950 ROLAND CLARKE PLACE, RESTON, VA, 20191, US

(73) Assignee: HAUNI MASCHINENBAU AG, Hamburg (DE)

(21) Appl. No.: 12/123,756

(22) Filed: May 20, 2008

Related U.S. Application Data
(63) Continuation of application No. PCT/EP2006/010125, filed on Oct. 20, 2006.

(30) Foreign Application Priority Data
Nov. 22, 2005 (DE) 10 2005 055 912.3

(51) Int. Cl. B41J 2/17

(52) U.S. Cl. 347/100

(57) ABSTRACT

Method for applying a printed mark to an article of the tobacco-processing industry. The method includes applying an ink based on a volatile and organic solvent to the article by at least one printing head.

### CROSS-REFERENCE TO RELATED APPLICATIONS

The present application is a Continuation of International Patent Application No. PCT/EP2006/010125 filed Oct. 20, 2006, and claims priority under 35 U.S.C. §119 of German Patent Application No. 10 2005 055 912.3 filed Nov. 22, 2005. Moreover, the disclosure of International Patent Application No. PCT/EP2006/010125 is expressly incorporated by reference herein in its entirety.

### BACKGROUND OF THE INVENTION

1. Field of the Invention

The invention relates to a method for applying a printed mark to an article of the tobacco-processing industry, e.g., to a wrapping strip, and preferably, a cigarette paper strip. Furthermore, the invention relates to a use of a printing head, in particular an inkjet printing head, in a machine of the tobacco-processing industry.

2. Discussion of Background Information

Printing units are known for applying printed marks to a wrapping strip of the tobacco-processing industry. For example, an imprint is applied to cigarette paper strips in a rod-maker (rod-making machine) with a printing roller. Rod-shaped articles such as cigarettes, cigarillos, cigars or filter rods or the like are produced in the rod-maker in a continuous process. The tobacco rods are wrapped with the wrapping strip in the rod-maker, the wrapping strips used having printed marks or printed images, which can be, e.g., cigarette brands, manufacturer names or other information.

Smoker's products mean cigarettes with and without filters and all other rod-shaped smoker's products with a wrapping strip that is printed. The imprint appearing on the products primarily denotes the brand. An imprint or stamp of this type is an obvious quality feature of products of this type and requires special care regarding the components and production conditions necessary for its production, such as type and condition of the ink used and its supply, transfer, distribution up to application to the wrapping strip.

EP-A-1 512 541 discloses a printing unit of the tobacco-processing industry, which has at least one ink jet printer cartridge for applying printed marks to a cigarette wrapping strip.

### SUMMARY OF THE INVENTION

Based on this prior art, the present invention improves the application of printed marks to a conveyed cigarette paper strip according to the principle of ink jet printing. In particular, the invention provides another method according to the principle of ink jet printing for applying printed marks to a conveyed wrapping strip, with which improved printed marks can be produced.

According to the invention, a method for applying a printed mark onto an article of the tobacco processing industry, e.g., onto a wrapping strip, and, preferably, onto a cigarette paper strip, includes forming the printed mark by applying an ink based on a volatile and organic solvent to the article by at least one printing head, in particular, an ink jet printing head.

The invention is based on the idea of using printing heads of a printing unit, in particular an ink jet printing unit, to apply solvent-based ink, which contains at least one volatile and organic solvent, onto a conveyed material strip. The printing head or the printing heads assemble the printed image on the material strips or cigarette papers strips from individual elements, pixels, dots, drops etc. analogously to the known ink jet printing methods.

The invention is directed to a method for applying a printed mark to an article of the tobacco-processing industry. The method includes applying an ink based on a volatile and organic solvent to the article by at least one printing head.

According to a feature of the invention, the article can include a wrapping strip, and the wrapping strip may include a cigarette paper strip.

In accordance with another feature of the invention, the at least one printing head may include an ink jet printing head.

According to still another feature of the instant invention, the solvent-based ink can include alcohol as a solvent.

In accordance with a further feature of the present invention, the solvent-based ink can include resin as a binder.

In accordance with still yet another feature of the present invention, the method can also include at least one of storing the solvent-based ink in at least one container of stainless steel and conveying the solvent-based ink in at least one line of stainless steel.

The invention is directed to a method of printing with a printing head in a machine of the tobacco-processing industry. The method includes applying an ink based on a volatile and organic solvent by the printing head onto an article of the tobacco-processing industry.

Other exemplary embodiments and advantages of the present invention may be ascertained by reviewing the present disclosure.

### DETAILED DESCRIPTION OF THE INVENTION

Printing units or ink jet printing units with at least one printing head used are printing units in machines of the tobacco-processing industry, which have a container or a chamber for at least one solvent-based ink. Depending on the application, the container can additionally have a printing head. For example, a stationary printing head of the printing unit can be connected to the reservoir directly or via a line.

It is generally known that ink jet printers work with two different physical principles. The piezo technology uses electric pulses that heat a thin-film resistance in the nozzle and thereby press a drop (of ink) out of the nozzle. In the piezo technology, which works with tiny crystals that are in each individual nozzle, the corresponding crystal is deformed by electric voltage. With the expansion of the crystal, the liquid is thrown onto the material strip. When the crystal contracts, ink is drawn in from the reservoir. In particular piezo-based inkjet printers permit an application of highly viscous liquids far above the viscosity of conventional paper ink.

The bubble-jet technology works with heat in combination with gas. A heating element hereby heats the liquid or ink in the reservoir so strongly that a gas bubble forms, which presses the liquid out of a nozzle. After the heating element has been switched off, a vacuum forms, through which a new quantity of liquid is drawn in from the reservoir.

According to the invention, solvent-based ink is applied to a conveyed material strip of the tobacco-processing industry to form an imprint or a printed mark, in order to further assemble the material strip for the production of tobacco rods or filters. The solvent-based ink or alcohol-based ink is characterized among other things by quick drying on the material strip, good adhesion and low flowout on the surface of the material strip.

Bacterial formation in the ink and a clogging of the nozzle are avoided through the use of a solvent, e.g., alcohol. Moreover, as no air bubbles form in the printing system due to the presence of alcohol in the ink, no foam develops either. In addition to the pigment and the solvent or alcohol, the solvent-based or alcohol-based ink according to the invention also contains resin as a binder, so that within a short period after the application of the ink to, for example, a porous cigarette paper or filter wrapping paper, the alcohol completely evaporates and only the ink for characterizing and forming the printed mark remains on the product. The binder hereby has the function of an adhesive.

In particular, it has been shown that solvent or alcohol is added to the ink to adjust the viscosity, the surface tension and the drying time. For example, the alcohol of the ink evaporates after application to the material strip or the cigarette paper within less than 1 second, so that the (remaining) ink remains on the cigarette paper strip without further additives. The volatile and organic solvent in the ink preferably has a boiling point below 160° C., preferably between 50° C. and 100° C.

If solvent-based ink is imprinted on the material strip by several printing heads, in particular, ink jet printing heads within the scope of the invention, it is likewise conceivable that the different printing heads can be supplied with different solvent-based inks. Thus, a colored imprint can be assembled from a targeted mixture of solvent-based inks and printed on the strip. Mixtures of this type can thus be provided easily and flexibly.

The conveyed material strip of the tobacco-processing industry is generally a conveyed article of the tobacco-processing industry to which a printed mark is applied or, as it were, imprinted. Within the scope of the invention a metered application of the solvent-based ink is carried out on the material strip in order to apply a predetermined defined printed pattern in a predetermined intensity. A desired specification and assembly of the material strip results through this. In particular, paper is used as carrier material for the applied writing or the imprinted image or logo or the like.

The application of the solvent-based ink onto the material strip guided past the printing unit or printing head is carried out in a contactless manner. Within the scope of the invention solvent-based inks are used thereby, all of which comply with the statutory provisions.

In particular the ink pigments of the ink and the binder, e.g., resin meet the statutory regulations. The ink pigments of the ink can be food-certified ink pigments, each of which meets the statutory provisions. The binder used is also a substance accordingly approved for imprint onto cigarette paper, tip paper and filter tipping paper.

Advantageously, the solvent-based ink has alcohol as an organic solvent.

In particular, the solvent-based ink has resin as a binder.

In a further development, it is proposed for the solvent-based ink to be stored in at least one container or containers of stainless steel and/or conveyed in at least one line or lines of stainless steel.

When several printing heads are arranged in and/or crosswise to the conveying direction of the conveyed material strip, the work area for applying or imprinting the solvent-based ink is thereby enlarged.

In particular, the printing heads are arranged in a cascading manner so that it is possible for respectively one ink jet printing head to print a specific area of the conveyed material strip with a solvent-based ink. Subsequently, another area of the printed mark is printed by a subsequent second ink jet printing head. Overall, the quality and/or density of the printed image is improved thereby. Furthermore, it is hereby possible to clearly increase the conveyer speed of the material strip.

Furthermore, the invention is directed to a method in which a printing head, in particular, an inkjet printing head, in a machine of the tobacco-processing industry forms a print mark. The method includes applying an ink based on a volatile and organic solvent by the printing head onto a material strip or article of the tobacco-processing industry, e.g., onto a wrapping strip, and preferably onto a cigarette paper strip. Advantages of using a solvent-based ink in a printing unit of the tobacco-processing industry or in a machine of the tobacco-processing industry are achieved for reasons set forth above.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A method for applying a printed mark to an article of the tobacco-processing industry, comprising:
applying an ink based on a volatile and organic solvent to the article by at least one printing head.

2. The method in accordance with claim 1, wherein the article comprises a wrapping strip.

3. The method in accordance with claim 2, wherein the wrapping strip comprises a cigarette paper strip.

4. The method in accordance with claim 1, wherein the at least on printing head comprises an ink jet printing head.

5. The method in accordance with claim 1, wherein the solvent-based ink comprises alcohol as a solvent.

6. The method in accordance with claim 1, wherein the solvent-based ink comprises resin as a binder.

7. The method in accordance with claim 1, further comprising at least one of:
storing the solvent-based ink in at least one container of stainless steel; and
conveying the solvent-based ink in at least one line of stainless steel.

8. A method of printing with a printing head in a machine of the tobacco-processing industry, comprising:
applying an ink based on a volatile and organic solvent by the printing head onto an article of the tobacco-processing industry.

9. The method in accordance with claim 8, wherein the printing head comprises an ink jet printing head.

10. The method in accordance with claim 8, wherein the article comprises a wrapping strip.

11. The method in accordance with claim 10, wherein the wrapping strip comprises a cigarette paper strip.

12. The method in accordance with claim 8, wherein the solvent-based ink comprises alcohol as a solvent.

13. The method in accordance with claim 8, wherein the solvent-based ink comprises resin as a binder.

14. The method in accordance with claim 8, further comprising at least one of:
storing the solvent-based ink in at least one container of stainless steel; and
conveying the solvent-based ink in at least one line of stainless steel.
